(19) United States
(12) Patent Application Publication
(10) Pub. No.: US 2001/0021238 A1
(43) Pub. Date: Sep. 13, 2001

(54) Method and apparatus for separating a neutron absorber from a coolant

(76) Inventors: Georg Lindner, Erlangen (DE); Manfred Meintker, Mohrendorf (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/771,674

(22) Filed: Jan. 29, 2001

Related U.S. Application Data
(63) Continuation of application No. PCT/DE99/02237, filed on Jul. 20, 1999.

(30) Foreign Application Priority Data
Jul. 27, 1998 (DE) 198 33 739.6

(51) Int. Cl. G21C 15/00; G21C 19/28

(52) U.S. Cl. 376/361

(57) ABSTRACT

A method and an apparatus for separating a neutron absorber from a coolant of a nuclear facility are provided. The coolant is evaporated by heating. Discharged coolant vapor is compressed in a compressor while the temperature increases and is used for the evaporation of further coolant. A fraction of the compressed coolant vapor is preferably fed to a condenser. A purging-gas configuration and a sealing-fluid configuration are preferably provided.

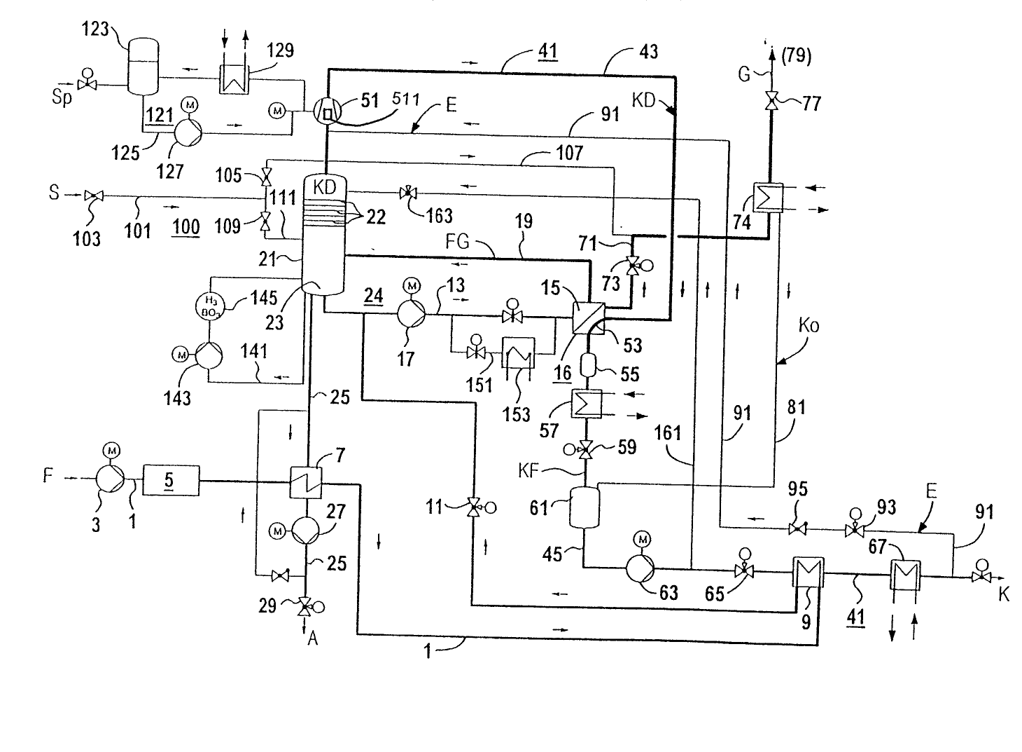

### CROSS-REFERENCE TO RELATED APPLICATION

This application is a continuation of copending International Application No. PCT/DE99/02237, filed Jul. 20, 1999, which designated the United States.

### BACKGROUND OF THE INVENTION

Field of the Invention

The invention relates to a method for separating a neutron absorber from a coolant of a nuclear facility. The coolant is evaporated by heating. Coolant vapor and the neutron absorber which remains behind are discharged separately. The invention also relates to an apparatus for separating a neutron absorber from a coolant of a nuclear facility.

Coolants, e.g. cooling water, in which a neutron absorber, e.g. boric acid, is dissolved are used in nuclear facilities. For example, a fluid which contains cooling water in which boric acid (so-called boric water) is dissolved is used for the cooling of a pressurized water reactor. For reasons related to the control of the coolant mass and/or the composition of the fluid, fluid is extracted from the cooling circuit of the pressurized water reactor and separated into cooling water (deionate) and concentrated boric acid solution. These two last-mentioned products are then reused by being fed again into the reactor cooling circuit in the desired dosage.

To separate the neutron absorber from the coolant, it is known to virtually completely evaporate the coolant to be separated. The vapor produced is normally cleaned of entrained boric acid in a plate column and condensed in a condenser, as a result of which the desired cooling water product (deionate), or generally “coolant”, is obtained. On account of its low vapor volatility, the boric acid dissolved in the fed coolant remains in the sump of the evaporator equipment and becomes concentrated there.

The desired neutron absorber product (concentrated boric acid solution), designated below as “absorber”, is obtained from the equipment by virtue of the fact that either boric acid solution with the desired concentration is drawn off continuously through the use of a concentration control or filling-level control and coolant is accordingly added (continuous method), or the process is interrupted upon reaching the desired concentration and the evaporator sump is emptied (discontinuous method).

In these methods used hitherto, the process heat required for the evaporation is fed with auxiliary steam, which is extracted, for example, from an auxiliary-steam supply network present in the power station.

This procedure has several disadvantages. Firstly, the requisite auxiliary-steam supply involves considerable investment costs due to corresponding lines, fittings and an auxiliary boiler plant. Secondly, a large heat quantity approximately equal to the process heat has to be discharged from the evaporator plant through the use of cooling water. Lines and fittings for the cooling-water supply likewise involve considerable investment costs. Thirdly, the heat output extracted from the auxiliary-steam supply network is at the expense of the electrical energy produced in the pressurized water reactor. As an initial approximation, the electrical energy not produced as a result of the hitherto conventional procedure, with due regard to a thermal efficiency (of about 34%), is equivalent to the heat quantity extracted from the auxiliary-steam supply network. The requisite heat output is approximately obtained from the product of desired deionate volumetric flow and the difference between the specific enthalpy of the steam in the evaporator and the fed boron-treated coolant. As a result, in a pressurized water reactor with an electrical output of about 1500 MW, losses may easily occur as a result of the evaporation of more than 5 MWₕₑₐₜ, e.g. 7 MWₕₑₐₜ corresponding to 2.4 MW_{electrical}.

From the book “Taschenbuch für den Maschinenbau” [pocket book for mechanical engineering], by Dubbel, 18th edition, 1995, Springer Publishers, pages N14 ff., it is known to use so-called vapor compression in order to save energy during the evaporation and crystallizing. In this case, the vapor discharging from an evaporator is compressed in a compressor. The temperature increase occurring in the vapor as a result allows to use the heat contained in the vapor for further heating of the liquid located in the evaporator.

### SUMMARY OF THE INVENTION

It is accordingly an object of the invention to provide a method and an apparatus for separating a neutron absorber from a coolant of a nuclear facility which overcome the above-mentioned disadvantages of the heretofore-known methods and apparatuses of this general type and through the use of which the neutron absorber can be separated from the coolant of the nuclear facility in a more cost-effective manner compared with the conventional procedure while at the same time saving energy.

With the foregoing and other objects in view there is provided, in accordance with the invention, a method for separating a neutron absorber from a coolant of a nuclear facility, which includes the steps of:

providing a neutron absorber in a coolant of a nuclear facility;

generating a coolant vapor by heating and evaporating the coolant;

discharging the coolant vapor and the neutron absorber remaining behind separately from one another;

compressing discharged coolant vapor in a compressor while increasing a temperature for providing compressed coolant vapor; and

using the compressed coolant vapor for evaporating further coolant.

In other words, the object of the invention is achieved in that discharged coolant vapor is compressed in a compressor while the temperature increases and is used for the evaporation of further coolant.

The discharged coolant vapor, through the use of compression, is therefore put into a state in which the heat contained in it can be utilized by virtue of the fact that the coolant vapor at the increased temperature is used for the evaporation of further coolant.

For solving the abovementioned object, the invention is based on the knowledge that vapor compression, contrary to what experts expected, can also be used in the nuclear technology sector, although the coolants used there are as a rule radioactively contaminated and in addition often contain noncondensable gases, which—in particular during the condensing of a vapor which has an inertizing effect—constitute an explosion risk.

According to another mode of the invention, a fraction of the compressed coolant vapor is fed to a condenser.

According to yet another mode of the invention, a noncondensable gas entrained in the fraction of the compressed coolant vapor is separated in the condenser and fed to an off-gas system.

According to a further mode of the invention, coolant condensed in the condenser is admixed with the compressed coolant vapor which is condensed by heat extraction during evaporation of the further coolant.

According to another mode of the invention, a noncondensable inert gas such as nitrogen is fed to the condenser.

According to yet another mode of the invention, an evaporator configuration, which is provided for evaporation of the further coolant, is flushed or purged with a noncondensable inert gas, such as nitrogen, after completion of the evaporation.

According to another mode of the invention, a sealing fluid, such as water, pressurizes or is applied to a sealing element which is provided for a shaft sealing of the compressor.

According to a further mode of the invention, a part of the discharged coolant vapor, which is condensed by heat extraction during evaporation of the further coolant, is fed as an injection fluid to a suction side or a pressure side of the compressor.

According to another mode of the invention, heat is extracted from the discharged neutron absorber or from the discharged coolant vapor, which is condensed by heat extraction during evaporation of the further coolant, and the heat is fed to coolant to be evaporated.

The discharged coolant vapor is preferably compressed to 1.5 to 2 times the pressure.

In a preferred embodiment of the method, a fraction of the compressed coolant vapor is fed to a condenser. As a result, it is advantageously possible to set a flow rate of a plant operating according to the method. To this end, the fraction may be drawn off from an evaporator. The fraction is preferably 1% to 5%.

A noncondensable gas entrained in the fraction is preferably separated in the condenser and fed to an off-gas or exhaust-gas system. As a result, the noncondensable gas is drawn off from a plant working according to the method. The noncondensable gas may be, for example, hydrogen, nitrogen or a radioactive inert gas or radioactive noble gas. If radioactive inert gases were to remain in the condensed coolant vapor in a high concentration, the “coolant” product would be contaminated in an inadmissible manner. If the noncondensable gas was not drawn off from the plant with the vapor/gas flow, it would collect there and substantially impair the heat transfer from the compressed coolant vapor to the further coolant to be evaporated. The concentration of noncondensable gases in the “coolant” product is advantageously kept low by separating noncondensable gases in the condenser and feeding them to an off-gas system.

For example, the coolant condensed in the condenser is admixed with the coolant vapor which is condensed by heat extraction during the evaporation of the further coolant. It is thus admixed with a condensate which has been produced by heat extraction during the evaporation of the further coolant from the compressed coolant vapor. As a result, the coolant condensed in the condenser is likewise available as “coolant” product.

A noncondensable inert gas, in particular nitrogen, is preferably fed to the condenser. A condenser operated in this way works in an especially safe manner, since a gas mixture which is certainly not explosive discharges from the condenser.

In another preferred embodiment of the method, an evaporator configuration provided for the evaporation is purged with a noncondensable inert gas, in particular nitrogen, after completion of the method. The evaporator configuration is purged with the noncondensable inert gas, for example after completion of the evaporation process, since otherwise, after completion of the evaporation process, an atmosphere of noncondensable gases which are entrained during operation with the coolant to be evaporated, e.g. hydrogen, nitrogen and/or radioactive inert gases (noble gases), could remain behind in the evaporator plant.

In another embodiment of the method, a sealing fluid, in particular water, is applied to a sealing element present for the shaft sealing of the compressor. This results in the advantage that no radioactive impurities can escape from the compressor into the environment and/or no contaminants can penetrate into the vapor side of the compressor.

In another preferred embodiment of the method, some of the discharged coolant vapor which is condensed by heat extraction during the evaporation of the further coolant is fed as injection fluid on the suction side or pressure side to the compressor. In a preferred configuration, the injection quantity is in this case set in such a way that the coolant vapor reaches the saturation state which is especially advantageous for use as heating vapor. If no external medium but only some of the discharged coolant vapor is fed on the suction side to the compressor, this advantageously achieves the effect that the quantity and quality of the coolant used in the plant and provided with a neutron absorber is not changed by the injection water.

In a further advantageous embodiment, heat is extracted from the discharged coolant vapor which is condensed by heat extraction during the evaporation of the further coolant, and/or from the discharged absorber, and is fed to the coolant to be evaporated.

With the objects of the invention in view there is also provided, in combination with a nuclear facility using a coolant, an apparatus for separating a neutron absorber from the coolant, including:

an evaporator configuration to be fed with the coolant for evaporating the coolant;

a compressor connected to the evaporator configuration and having a suction side and a pressure side, the compressor being fed, on the suction side, with the coolant evaporated in the evaporator configuration;

the evaporator configuration having a heat-transfer device for condensing the coolant, the heat-transfer device being connected to the pressure side of the compressor;

a coolant condensate line connected to the heat-transfer device for discharging the coolant condensed in the heat-transfer device; and

an absorber line connected to the evaporator configuration for discharging the neutron absorber remaining behind in the evaporator configuration.

In other words, the object of the invention relating to the apparatus is achieved by:

a) an evaporator configuration to which the coolant can be fed,

b) a compressor to which coolant evaporated in the evaporator configuration can be fed on the suction side,

c) a heat-transfer device of the evaporator configuration, the heat-transfer device being connected to the pressure side of the compressor,

d) a coolant condensate line, via which coolant condensed in the heat-transfer device can be discharged, and

e) an absorber line, via which absorber remaining behind in the evaporator configuration can be discharged.

The apparatus is especially suitable for carrying out the method according to the invention. The advantages mentioned in connection with the method apply to the apparatus in a similar manner.

According to a preferred feature of the invention, a condenser is provided to which some of the coolant vapor compressed in the compressor can be fed. Through the use of the condenser, noncondensable gases can advantageously be drawn off from the evaporator configuration and from lines to which vapor is admitted.

The condenser is preferably connected to the coolant condensate line via a condensate line. As a result, coolant condensed in the condenser can be fed to the coolant condensate line which carries the “coolant” product.

Furthermore, the condenser is preferably connected to an off-gas system. As a result, the non-condensable gases separated in the condenser can advantageously be supplied for safe utilization.

In a preferred embodiment, the apparatus has a purging-gas line, with which a noncondensable inert gas, in particular nitrogen, can be fed to the evaporator configuration and/or the condenser.

Via the purging-gas line, by feeding the noncondensable inert gas, a non-explosive gas mixture can advantageously be produced in those apparatus components in which an explosion risk is to be expected as a result of noncondensable hydrogen.

According to another feature of the invention, the apparatus includes a sealing-fluid configuration, with which a sealing fluid can be applied to a sealing element of the compressor. As a result, the compressor is sealed in an especially effective manner, which is especially advantageous for the nuclear technology sector, which is extremely sensitive from the safety point of view.

In an advantageous embodiment of the apparatus, some of the coolant vapor condensed in the heat-transfer device can be fed via an injection line on the suction side or pressure side to the compressor.

This portion is preferably 8% to 12%.

There is preferably a first heat exchanger, with which heat can be extracted from the absorber discharged via the absorber line and can be fed to coolant flowing to the evaporator

There may also be a second heat exchanger, with which heat can be extracted from the coolant discharged via the coolant condensate line and can be fed to coolant flowing to the evaporator configuration.

In this way, residual heat present is utilized for the evaporation process.

Without the heat exchanger(s), further feeding of external energy would be necessary.

Other features which are considered as characteristic for the invention are set forth in the appended claims.

Although the invention is illustrated and described herein as embodied in a method and apparatus for separating a neutron absorber from a coolant, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE is a schematic elementary diagram of an apparatus according to the invention having an evaporator configuration working according to the principle of vapor compression.

### DESCRIPTION OF THE PREFERRED EMBODIMENTS

Referring now to the single FIGURE of the drawing in detail, there is shown an apparatus according to the invention which is an integral part of a nuclear facility or of a nuclear power station. In detail, the drawing shows a fluid line 1, to which fluid F, namely boron-treated coolant from a nuclear power station, can be fed. The fluid F is delivered from a receiver vessel (not shown) via an evaporator feed pump 3. The fluid F is directed via the fluid line 1 to a cleaning plant 5. In order to largely preheat the fluid to the evaporation temperature, it is directed via two recuperative heat exchangers 7, 9. In the process, heat is extracted from the product flows of the apparatus, namely a product flow containing absorber A and a product flow containing coolant K.

Provided in the fluid line 1 is an inflow control valve 11, via which the inflowing fluid flow can be set. The inflow control valve 11 also serves as a final control element for a filling-level control of the plate column 21.

The fluid line 1 opens into a first connecting line 13, via which the fluid F, driven by an evaporator circulating pump 17, passes to a vapor space 15 of an evaporator 16. The vapor space 15 is connected to a plate column 21 via a vapor line 19. The plate column 21 has a plurality of separator plates 22 provided one above the other. The first connecting line 13 branches off from the sump 23 of the plate column 21.

The circulation system formed from the evaporator 16 and the plate column 21 and also the first connecting line 13 and the vapor line 19 forms an evaporator configuration 24, designated overall as such.

The circulating flow FG circulated via the first connecting line 13 and the vapor line 19 is about 150 times the desired evaporation quantity (evaporation flow). This achieves the effect that, during the feeding of the heat required for the evaporation, only the saturation state of the liquid fluid F is achieved in the evaporator 16, and that the actual evaporation of the desired quantity—caused by a pressure loss—is not effected until at the entry to the plate column 21.

The circulating flow may also be 100 times to 200 times the evaporation flow.

The separation into a partial flow of coolant vapor KD and the remaining liquid quantity is effected in the bottom part of the plate column 21 by force of gravity and by inertia forces. Whereas the remaining liquid quantity continues to be circulated in the circulation circuit of the evaporator plant 24, the coolant vapor KD rises above the separator plates 22 to the head of the plate column 21, in the course of which it is further cleaned of entrained absorber fractions (boric-acid fractions) on each plate 22 by counterflowing liquid. The completely cleaned coolant vapor KD discharges at the head of the plate column 21 at a temperature which corresponds to the boiling state of the liquid on the topmost plate of the plate column 21.

The desired product flow “absorber A” (concentrated boric acid solution) is drawn off from the sump 23 of the plate column 21 via an absorber line 25 through the use of an absorber delivery pump 27. This product flow, which can be adjusted via an absorber outflow control valve 29, is delivered into a storage reservoir (not shown) which is provided for this purpose. The boric acid solution in the boiling state is directed beforehand via a first recuperative heat exchanger 7, where, as described above, it gives off some of its heat for preheating the fluid F to be evaporated, which flows to the evaporator plant 24. The absorber can be fed from the storage reservoir for reuse, e.g. for treating the coolant of the nuclear facility with boron.

The completely cleaned coolant vapor KD, via a coolant line 41 which is attached to the head of the plate column 21 and, for the sake of clarity, is designated with its first part as coolant vapor line 43 and with its second part—in the flow direction downstream of the evaporator 16—as coolant condensate line 45, is drawn in by a compressor 51 and compressed to about 1.8 times the pressure. As a result, the coolant vapor KD heats up. In order to avoid overheating of the compressor 51 on the one hand, and in order to produce a saturation state of the coolant vapor KD on the other hand, this saturation state being especially advantageous for the use, which is described below, as heating vapor, water is injected into the drawn-in vapor flow (via the injection line 91 described further below) upstream of the vapor connection of the compressor 51, and this water evaporates during the compression process. Depending on the type of construction of the compressor, the injection may also be effected on the pressure side. This is because, for example, a turbo-compressor is not sensitive to temperature but to droplets in the delivery flow.

The vapor, which, compared with the suction side (about 100° C.), is now at a markedly higher temperature of about 117° C., is fed via the coolant vapor line 43 to a heat-transfer device or heat-transfer area 53 of the evaporator 16. The heat-transfer device 53, for reasons of clarity, is reproduced in a schematic manner only by a single curve of a heating line and actually is formed of a plurality of heating coils or heating tubes (tube bundles).

The coolant vapor KD condenses in the heat-transfer device 53 and in the process gives off the enthalpy of vaporization contained in it for heating the evaporator circulating flow flowing in the vapor space 15 of the evaporator 16.

The condensate, which forms on the heating side in the evaporator 16, i.e. in the heat-transfer device 53, and is designated below as liquid coolant KF, constitutes the second desired product flow “coolant K” (deionate). It is fed via the coolant condensate line 45 first of all to a condensate collector 55 and is drained through the use of a filling-level controlled condensate-outflow control valve 59 into a condensate receiver 61, in which a low pressure prevails, which is imposed, for example, via the connected off-gas system 79 (described further below) of a power station plant. So that no re-evaporation occurs when the condensate is being drawn off, a condensate cooler 57 is provided upstream of the condensate-outflow control valve 59, in which condensate cooler 57 the condensate temperature is reduced to just below the saturation temperature pertaining to the pressure in the condensate receiver 61.

The coolant KF produced, controlled by a coolant control valve 65, is delivered by an evaporator condensate pump 63 into a storage reservoir (not shown). In addition, the liquid coolant KF, when flowing through the coolant condensate line 45, is directed via the second recuperative heat exchanger 9, in the course of which it gives off some of its heat for preheating the fluid F flowing to the evaporator plant 24. If need be, the liquid coolant KF is cooled in a downstream recooler 67 to the temperature necessary for subsequent reuse, e.g. approximately 50° C.

Branching off from the evaporator 16 on the vapor side is a discharge line 71, with which a small fraction of excess coolant vapor KD, adjustable via a vapor adjusting valve 73, can be directed to a condenser 74. On the one hand, this enables the output of the evaporator plant 24 to be adjusted. On the other hand, noncondensable gases G which are dissolved in the inflowing fluid F and are released during the evaporation process are drawn off with this drawn off vapor low from the apparatus according to the invention, i.e. in particular from the evaporator configuration 24. The noncondensable gases G essentially include hydrogen (explosion risk), nitrogen and radioactive inert or noble gases. They are directed via a first valve 77 to an off-gas system, which is indicated only by reference numeral 79, of the nuclear power station.

By using a geodetically falling gradient or downward incline, the condensate Ko collecting in the condenser 74 is directed via a condensate line 81 into the condensate receiver 61 and constitutes some of the product “coolant K” (deionate) produced in the apparatus according to the invention.

At the end, some of the coolant KF produced and cooled is extracted from the coolant condensate line 45 via an injection line 91 and is sprayed as injection fluid E on the suction side of the compressor 51 into the coolant vapor flow KD. As a result, overheating of the compressor 51 is avoided on the one hand, and the saturation state of the coolant vapor KD is produced on the other hand, this saturation state being especially advantageous for use as heating vapor. Since no external medium but only a partial flow of the coolant KF produced is used, this achieves the effect that the quantity and quality of the boron-treated coolant used in the plant are not changed by the injection water E. In this case, quality means a low content of dissolved impurities, which are not admissible in the cooling circuit of a nuclear reactor. An increase in the coolant quantity through use of external medium would necessitate an undesirable delivery of radioactively contaminated coolant to the environment.

A partial quantity of 8% to 12% of the coolant flow produced is branched off by an injection adjusting valve provided in the injection line 91.

Furthermore, the injection fluid E is directed via a second valve 95 which, in the event of a change in the pressure conditions in the apparatus, for example if the evaporator condensate pump 63 fails, serves to prevent an undesirable backflow. A further valve 93 may be provided in the injection line 91.

Furthermore, the apparatus according to the invention shown by way of example in the drawing includes a purging-gas configuration 100, having a purging-gas line 101 and a purging-gas valve 103. A noncondensable, inertizing gas, e.g. nitrogen, can be fed via the purging-gas line 101 to both the evaporator configuration 24 and the condenser 74. For this purpose, a first purging-gas branch line 107 having a third valve 105 and a second purging-gas branch line 111 having a fourth valve 109 branch off from the purging-gas line 101.

In the region of the coolant vapor line 43, which extends from the plate column 21 up to the evaporator 16, and in the region of the discharge line 71 between the evaporator 16 and the condenser 74, there is sufficient inertizing vapor during the operation of the apparatus in order to rule out an explosion of the hydrogen. Before entering the condenser 74, purging gas S is admixed via the first purging-gas branch line 107, so that a nonexplosive gas mixture is likewise ensured downstream of the condenser 74 in the flow direction indicated.

After the operation of the apparatus according to the invention has ended, the remaining vapor condenses, and an atmosphere formed from the noncondensable gases remains behind. Via the fourth valve 109, the purging gas S is then fed via the second purging-gas branch line 111 to the plate column 21 and/or to another part of the evaporator configuration 24, so that the entire space to which vapor is admitted during the operation is freely purged by the purging gas S via the coolant vapor line 43 and the discharge line 41 to the off-gas system 79. The third valve 105 is closed in this case.

Furthermore, the apparatus shown in the drawing has a sealing-fluid configuration 121. It includes a sealing-fluid tank 123, to which a sealing fluid Sp, e.g. water (deionate), can be fed. Via a sealing-fluid line 125, sealing fluid Sp is drawn in from the sealing-fluid tank 123 through the use of a sealing-fluid pump 127 and fed to the compressor 51. In the compressor 51, the double-acting mechanical face seals 511, e.g. of a shaft seal, are supplied with deionate as sealing fluid Sp. In this way, no radioactivity can escape from the compressor 51 into the environment and no contaminants, e.g. oil from the bearing configuration of the compressor shafts, can penetrate into the coolant vapor line 43.

In an alternative configuration with a turbocompressor, which has a different sealing technique, gas (nitrogen/compressed air) is used as the sealing medium. This sealing gas need not be cooled and, if need be, can be extracted directly from a corresponding supply network.

The sealing fluid Sp, which is used once in the compressor 51, is fed via a return line to the sealing-fluid tank 123. A sealing-fluid cooler 129 is optionally provided in the return line in order to compensate for any temperature increase in the sealing fluid Sp. The sealing fluid Sp is therefore mostly circulated.

Branching off from the sump 23 of the plate column 21 is a branch line 141 with which a small portion of the absorber A, driven by an absorber-measuring pump 143, can be fed to an absorber-measuring device 145. After passing the absorber-measuring device 145, this portion passes back into the plate column 21. The absorber-measuring device 145 serves as an actual-value sensor for a concentration control for the circulating flow in the evaporator configuration 24. In this case, the absorber-outflow control valve 29 serves as final control element.

The simultaneous use of the filling-level control referred to further above for the plate column 21 and the concentration control described in the last paragraph advantageously results in the effect that

a) the filling of the circulation circuit of the evaporator configuration 24 always remains constant irrespective of the product flows A, K extracted, and

b) the absorber concentration of the medium in the circulation circuit of the evaporator configuration 24 and thus in the extraction flow always remains constant irrespective of the quantity and the concentration of the inflow of fluid F, e.g. at around 4% boric acid.

Attached to the first connecting line 13 of the evaporator configuration 24 is a bypass line 151, which is directed via an electric preheater 153. Through the use of the latter, as well as through the use of the evaporator circulating pump 17, the apparatus can be heated up from the cold state until sufficient vapor is available for the operation of the compressor 51 and steady on-load operation of the apparatus can be started. During steady on-load operation, the electric preheater 153 is switched off and the bypass line 151 is closed through the use of the valve depicted.

Branching off from the coolant condensate line 45, in particular on the pressure side at the evaporator condensate pump 63, is a return line 161, which has a return control valve 163 and opens out in the plate column 21, in particular in its head. A fraction of the coolant KF produced, which is set with the return control valve 163 preferably to about 20%, is thus fed to the plate column 21. From the head of the plate column 21, this fraction runs in counterflow to the rising coolant vapor KD via the plates 22 back into the sump 23 of the plate column 21. This runback in counterflow produces the desired purity of the coolant vapor KD discharging via the coolant line 41.

A pressure graduation in the condensate collection is made possible through the use of the condensate-outflow control valve 59, and this pressure graduation enables the condensate Ko collecting in the condenser 74 to return into the product flow of the coolant condensate line 45 without disturbance.

The coolant control valve 65, as final control element, controls the filling level of the condensate receiver 61. This control produces a constant filling level in the condensate receiver 61, which as a result can always receive inflowing condensate KF, Ko and stores sufficient medium for the suction side of the evaporator condensate pump 63.

With the apparatus according to the invention as shown, a marked cost reduction compared with the evaporation method used hitherto is achieved. This cost reduction is already achieved when the investment costs alone are considered. This is because, in contrast to the known methods, no auxiliary-steam supply has to be installed, for example. An additional reduction of the operating costs is obtained due to the fact that, for a nuclear power station of the 1300 MW output class, the energy demand for the evaporation decreases from about 6 MW for a heating with auxiliary steam to about 0.8 MW for the electrical power required for a heating with vapor compression.

We claim:

1. A method for separating a neutron absorber from a coolant of a nuclear facility, the method which comprises:
providing a neutron absorber in a coolant of a nuclear facility;
generating a coolant vapor by heating and evaporating the coolant;
discharging the coolant vapor and the neutron absorber remaining behind separately from one another;
compressing discharged coolant vapor in a compressor while increasing a temperature for providing compressed coolant vapor; and
using the compressed coolant vapor for evaporating further coolant.

2. The method according to claim 1, which comprises feeding a fraction of the compressed coolant vapor to a condenser.

3. The method according to claim 2, which comprises:
separating, in the condenser, a noncondensable gas entrained in the fraction; and
feeding the noncondensable gas to an off-gas system.

4. The method according to claim 2, which comprises admixing coolant condensed in the condenser with the compressed coolant vapor which is condensed by heat extraction during evaporation of the further coolant.

5. The method according to claim 2, which comprises feeding a noncondensable inert gas to the condenser.

6. The method according to claim 2, which comprises feeding nitrogen as a noncondensable inert gas to the condenser.

7. The method according to claim 1, which comprises purging an evaporator configuration, which is provided for evaporation of the further coolant, with a noncondensable inert gas after completion of the evaporation.

8. The method according to claim 1, which comprises purging an evaporator configuration, which is provided for an evaporation of the further coolant, with nitrogen as a noncondensable inert gas after completion of the evaporation.

9. The method according to claim 1, which comprises applying a sealing fluid to a sealing element which is provided for a shaft sealing of the compressor.

10. The method according to claim 1, which comprises applying water as a sealing fluid to a sealing element which is provided for a shaft sealing of the compressor.

11. The method according to claim 1, which comprises feeding a part of the discharged coolant vapor, which is condensed by heat extraction during evaporation of the further coolant, as an injection fluid, to a suction side of the compressor.

12. The method according to claim 1, which comprises feeding a part of the discharged coolant vapor, which is condensed by heat extraction during evaporation of the further coolant, as an injection fluid, to a pressure side of the compressor.

13. The method according to claim 1, which comprises:
extracting heat from the discharged coolant vapor, which is condensed by heat extraction during evaporation of the further coolant; and
feeding the heat to coolant to be evaporated.

14. The method according to claim 1, which comprises:
extracting heat from the neutron absorber being discharged; and
feeding the heat to coolant to be evaporated.

15. In combination with a nuclear facility using a coolant, an apparatus for separating a neutron absorber from the coolant, comprising:
an evaporator configuration to be fed with the coolant for evaporating the coolant;
a compressor connected to said evaporator configuration and having a suction side and a pressure side, said compressor being fed, on said suction side, with the coolant evaporated in said evaporator configuration;
said evaporator configuration having a heat-transfer device for condensing the coolant, said heat-transfer device being connected to said pressure side of said compressor;
a coolant condensate line connected to said heat-transfer device for discharging the coolant condensed in said heat-transfer device; and
an absorber line connected to said evaporator configuration for discharging the neutron absorber remaining behind in said evaporator configuration.

16. The apparatus according to claim 15, including a condenser connected to said compressor for receiving some of the coolant evaporated in said evaporator configuration and compressed in said compressor.

17. The apparatus according to claim 16, including a condensate line connecting said condenser to said coolant condensate line.

18. The apparatus according to claim 16, including an off-gas system connected to said condenser.

19. The apparatus according to claim 16, including a purging-gas line connected to at least one element selected from the group consisting of said evaporator configuration and said condenser for feeding a noncondensable inert gas.

20. The apparatus according to claim 16, including a purging-gas line connected to at least one element selected from the group consisting of said evaporator configuration and said condenser for feeding nitrogen.

21. The apparatus according to claim 15, wherein:
said compressor has a sealing element; and
a sealing-fluid configuration is connected to said compressor for applying a sealing fluid to said sealing element.

22. The apparatus according claim 15, including an injection line connected to said compressor for feeding some of the coolant condensed in said heat-transfer device to a side of said compressor selected from the group consisting of said suction side and said pressure side.

23. The apparatus according to claim 15, including a heat exchanger connected to said absorber line for extracting heat from the neutron absorber discharged via said absorber line and feeding the heat to the coolant flowing to said evaporator configuration.

24. The apparatus according to claim 15, including a heat exchanger connected to said coolant condensate line for extracting heat from the coolant condensed in said configuration and discharged via said coolant condensate line and feeding the heat to the coolant flowing to said evaporator configuration.
